(19) United States
(12) Patent Application Publication
(10) Pub. No.: US 2011/0219257 A1
(43) Pub. Date: Sep. 8, 2011

(54) IDLE-STATE DETECTION CIRCUIT, SEMICONDUCTOR INTEGRATED CIRCUIT, AND IDLE-STATE DETECTION METHOD

(75) Inventor: Genichiro MATSUDA, Nara (JP)

(73) Assignee: Panasonic Corporation, Osaka (JP)

(21) Appl. No.: 13/110,328

(22) Filed: May 18, 2011

Related U.S. Application Data
(63) Continuation of application No. PCT/JP2009/001590, filed on Apr. 6, 2009.

(30) Foreign Application Priority Data
Nov. 20, 2008 (JP) 2008-296726

(51) Int. Cl. G06F 9/30; G06F 1/04

(52) U.S. Cl. 713/600; 712/220; 712/E09.016

(57) ABSTRACT

An idle-state detection circuit detects that the processor repeats every predetermined number of clocks an operation to load data satisfying a preset idle-state condition from a particular address, and determines that the processor is in an idle state if the number of iterations is greater than a preset specified number of loops.

### CROSS-REFERENCE TO RELATED APPLICATION

This is a continuation of PCT International Application PCT/JP2009/001590 filed on Apr. 6, 2009, which claims priority to Japanese Patent Application No. 2008-296726 filed on Nov. 20, 2008. The disclosures of these applications including the specifications, the drawings, and the claims are hereby incorporated by reference in its entirety.

### BACKGROUND

The technology disclosed in this specification relates to circuits and methods for detecting an idle state of a processor.

In recent years, processor performance has been improving even further, and thus the operating power of processors has been increasing. Since mobile devices, such as cellular phones, operate on batteries, reduction in power consumption is required for achieving a long-term continuous operation. In addition, devices other than mobile devices also have issues of heat dissipation etc., and therefore achieving a maximum reduction in power consumption of processors is a critical issue for present-day LSI designing.

An effective technique for reducing power consumption of a processor is to reduce an operating frequency of the processor. However, reduction in an operating frequency obviously means degradation in processing performance of the processor, thereby leads to degradation in product performance if simply the operating frequency is reduced. Meanwhile, analysis of processor operation states shows that a period exists during which the processor is in a state (i.e., idle state) in which the processor is waiting for an instruction from the outside world (e.g., key input, mouse operation, etc.). A reduction in the operating frequency of a processor when the processor is in an idle state has very little effect on users. Therefore, detection of an idle state of a processor and reduction in the operating frequency of the processor during an idle state allows the power consumption of the processor to be reduced without degrading the performance in practical applications.

Referring to FIG. 8, an idle state of a processor will now be described. First, when a process is complete, the processor determines whether or not there are any more processes left to be performed (ST81). If there is a process left to be performed, the processor performs the process to be performed. On the other hand, if there are no more processes left to be performed, the processor loads a register value of a key input interface (ST82). Then, the processor determines whether or not the loaded register value indicates that key input exists (ST83). If the register value indicates that key input exists, then the processor performs a process according to the key input. Meanwhile, if the register value indicates that no key inputs exist, then the processor loads again a register value of the key input interface. Thus, the processor repeats steps ST82 and ST83 until a key input is detected. This iterative state is an idle state.

Conventionally, there have been idle-state detection techniques in which an idle state of a processor is detected using software. In such techniques, software is designed so as to set a flag indicating that the processor is in an idle state when the processor transitions to a state waiting for an instruction from the outside world. However, in order to design such software, software designers need to know which processings will place the processor in an idle state, thereby causes the man-hours for designing to be increased. Meanwhile, Japanese Patent Publication No. H08-123576 discloses an idle-state detection device which detects an idle state of a processor using hardware. In this idle-state detection device, the instruction addresses referred to by the processor are previously stored, and when the processor refers to a same instruction address every predetermined period, it is determined that the processor is executing a loop, and then the number of loop executions is counted up. If the number of loop executions exceeds a predetermined number of loops, it is determined that the processor is in an idle state.

### SUMMARY

However, when the processor is executing a loop, a conventional idle-state detection device may incorrectly detect an idle state of a processor even if the process is not actually an idle state. For example, a copy process is a process which may cause such an incorrect detection.

Referring to FIG. 9, a copy process by a processor will now be described. Here, assume that registers A, B, and C respectively store an address from which data is copied (source address), an address to which data is copied (destination address), and a last address. First, the processor refers to the register A, and loads data stored in the source address (ST91). Next, the processor refers to the register B, and stores the loaded data in the destination address (ST92). Then, the processor respectively increments the source address stored in the register A and the destination address stored in the register B (ST93). Thereafter, the processor refers to the registers A and C, and compares the source address stored in the register A with the last address stored in the register C (ST94). If the source address and the last address match, then the copy process is terminated; if the source address and the last address do not match, then the process loops back to step ST91 (ST95). Thus, until the source address and the last address match, the process of steps ST91-ST95 is repeated every predetermined number of cycles.

In such a loop, the processor refers to a same instruction address every predetermined period, thereby creating the possibility for a conventional idle-state detection device to incorrectly detect an idle state of the processor.

Thus, it is an object of the technology disclosed in this specification to provide a technology for correctly detect an idle state of a processor.

According to an aspect of the present invention, an idle-state detection circuit is a circuit for detecting an idle state of a processor, including an iterative-operation detection section configured to detect that the processor repeats every predetermined number of clocks an operation to load data satisfying a preset idle-state condition from a particular address, and a decision section configured to compare a number of iterations detected by the iterative-operation detection section with a preset specified number of loops, and to determine that the processor is in an idle state if the number of iterations is greater than the specified number of loops. Since this idle-state detection circuit can prevent a conventional incorrect detection, an idle state of the processor can be correctly detected.

According to another aspect of the present invention, a semiconductor integrated circuit includes the idle-state detection circuit, the processor, and a driver circuit configured to supply a clock signal and a drive voltage for driving the processor to the processor, where the driver circuit reduces at least one of a frequency of the clock signal or a voltage value of the drive voltage if it is determined by the decision section that the processor is in an idle state. This semiconductor IC can reduce waste of power in the processor.

According to still another aspect of the present invention, an idle-state detection method is a method for detecting an idle state of a processor, including the steps of (a) detecting that the processor repeats every predetermined number of clocks an operation to load data satisfying a preset idle-state condition from a particular address, and (b) determining that the processor is in an idle state if a number of iterations detected in the step (a) is greater than a preset specified number of loops. Since this idle-state detection method can prevent a conventional incorrect detection, an idle state of the processor can be correctly detected.

### BRIEF DESCRIPTION OF THE DRAWINGS

FIG. 1 is a diagram illustrating an example configuration of a semiconductor IC according to the first embodiment.

FIG. 2 is a flowchart for explaining an idle state of the processor shown in FIG. 1.

FIGS. 3A and 3B are each a flowchart for explaining an operation of the idle-state detection circuit shown in FIG. 1.

FIG. 4 is a diagram illustrating an example configuration of a semiconductor IC according to the second embodiment.

FIGS. 5A and 5B are each a flowchart for explaining an operation of the idle-state detection circuit shown in FIG. 4.

FIG. 6 is a diagram illustrating an example configuration of a semiconductor IC according to the third embodiment.

FIGS. 7A and 7B are each a flowchart for explaining an operation of the idle-state detection circuit shown in FIG. 6.

FIG. 8 is a flowchart for explaining an idle state of a processor.

FIG. 9 is a flowchart for explaining a copy process executed by a processor.

### DETAILED DESCRIPTION

Example embodiments of the present invention will be described below in detail with reference to the drawings, in which like reference characters indicate the same or equivalent components.

### First Embodiment

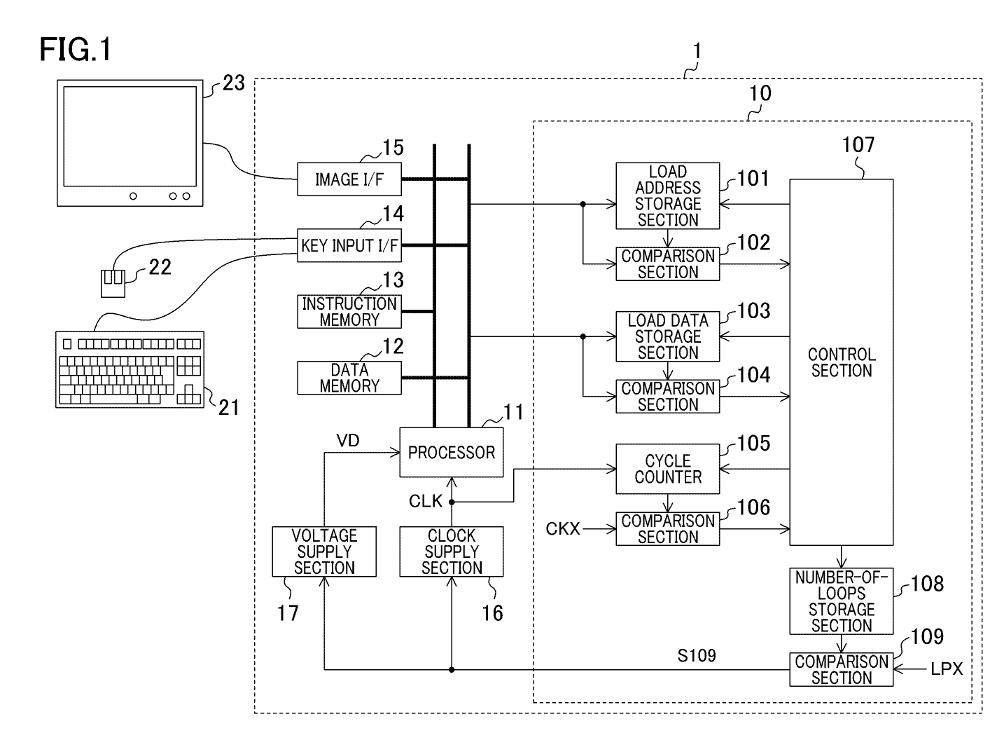

FIG. 1 illustrates an example configuration of a semiconductor integrated circuit (IC) 1 according to the first embodiment. The semiconductor IC 1 is used as a part of a program execution device having peripheral devices such as a keyboard 21, a mouse 22, and a display 23. The semiconductor IC 1 includes a processor 11, a data memory 12 which stores data, an instruction memory 13 which stores instructions, a key input interface 14 connected to both the keyboard 21 and the mouse 22, an image interface 15 connected to the display 23, an idle-state detection circuit 10 which detects an idle state of the processor 11, a clock supply section 16 which supplies a clock signal CLK for driving the processor 11, and a voltage supply section 17 which supplies a drive voltage VD for driving the processor 11.

<Processor>

In order to execute a program, the processor 11 requests the instruction memory 13 to transfer an instruction stored in an instruction address indicated by a program counter (not shown) provided in the processor 11. In response to the request from the processor 11, the instruction memory 13 transfers the instruction stored in the instruction address to the processor 11. Then, the processor 11 executes the instruction transferred from the instruction memory 13, and requests the instruction memory 13 to transfer a next required instruction. In this way, the processor 11 executes a program.

When the processor 11 reads data from the data memory 12 or any of the peripheral devices (here, the keyboard 21, the mouse 22, or the display 23), the processor 11 sends a data request to the data memory 12 or an intended peripheral device via the key input interface 14 or via the image interface 15. For example, the processor 11 requests the data memory 12 or the intended peripheral device to transfer data stored in the address indicated by an instruction according to the instruction transferred from the instruction memory 13. The data memory 12 or the intended peripheral device transfers the data requested by the processor 11 to the processor 11 in response to the data request received from the processor 11.

Meanwhile, when the processor 11 writes data to the data memory 12 or any of the peripheral devices, the processor 11 sends data to write and an address to write the data to, to the data memory 12 or an intended peripheral device. The data memory 12 or the intended peripheral device stores the data transferred from the processor 11 in the address specified by the processor 11.

The user performs various operations using the keyboard 21 and/or the mouse 22. Operations performed on the keyboard 21 and/or the mouse 22 are sent via the key input interface 14 to the processor 11. In addition, the user confirms the process result generated by the processor 11 etc. using the display 23 connected via the image interface 15.

<Idle State of Processor>

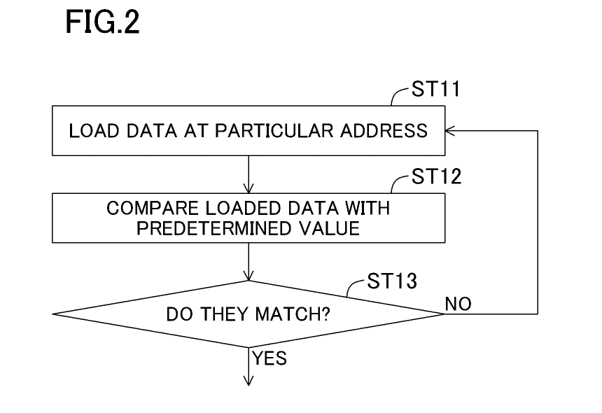

Here, referring to FIG. 2, an idle state (a state waiting for an external instruction) of the processor 11 will be described in detail. For simplicity of the description herein, it is assumed that “address A” denotes a particular address where data indicating whether any external instruction exists or not is stored, and the data stored in the address A represents “0” if no external instructions exist, and “1” if an instruction has been provided to execute another process from the outside world.

First, the processor 11 loads data stored in the address A (ST11), and compares the loaded data with a predetermined value (here, “1”) (ST12). If the loaded data and the predetermined value does not match, then the process loops back to step ST11 (ST13). Thus, the process of steps ST11, ST12, and ST13 is repeated until the loaded data matches the predetermined value (i.e., until an external instruction is received).

<Idle-State Detection Circuit>

Returning to FIG. 1, the idle-state detection circuit 10 includes a load address storage section 101, a comparison section 102, a load data storage section 103, a comparison section 104, a cycle counter 105, a comparison section 106, a control section 107, a number-of-loops storage section 108, and a comparison section 109.

The load address storage section 101 stores an address referred to by the processor 11 (an address from which data is loaded by the processor 11) in response to a control operation by the control section 107. The comparison section 102 compares the address referred to by the processor 11 with the address stored in the load address storage section 101.

The load data storage section 103 stores data loaded by the processor 11 in response to a control operation by the control section 107. The comparison section 104 compares the data loaded by the processor 11 with the data stored in the load data storage section 103.

The cycle counter 105 counts the number of clock cycles of the clock signal CLK supplied to the processor 11 in response to a control operation by the control section 107. The comparison section 106 compares the number of clock cycles counted by the cycle counter 105 with a preset specified number of cycles CKX.

The control section 107 controls the load address storage section 101, the load data storage section 103, and the cycle counter 105. In addition, the control section 107 adds “1” to the number of loops (increments the number of loops) stored in the number-of-loops storage section 108 according to the respective comparison results of the comparison sections 102, 104, and 106. The comparison section 109 compares the number of loops stored in the number-of-loops storage section 108 with a preset specified number of loops LPX; and asserts an idle-state notification signal S109 if the number of loops is greater than the specified number of loops LPX, and negates the idle-state notification signal S109 if the number of loops is less than or equal to the specified number of loops LPX.

The clock supply section 16 reduces the frequency of the clock signal CLK when the idle-state notification signal S109 transitions from a negated to an asserted state, and returns the frequency of the clock signal CLK to an original value when the idle-state notification signal S109 transitions from an asserted to a negated state.

The voltage supply section 17 reduces the voltage value of the drive voltage VD when the idle-state notification signal S109 transitions from a negated to an asserted state, and returns the voltage value of the drive voltage VD to an original value when the idle-state notification signal S109 transitions from an asserted to a negated state.

<Operation of Idle-State Detection Circuit>

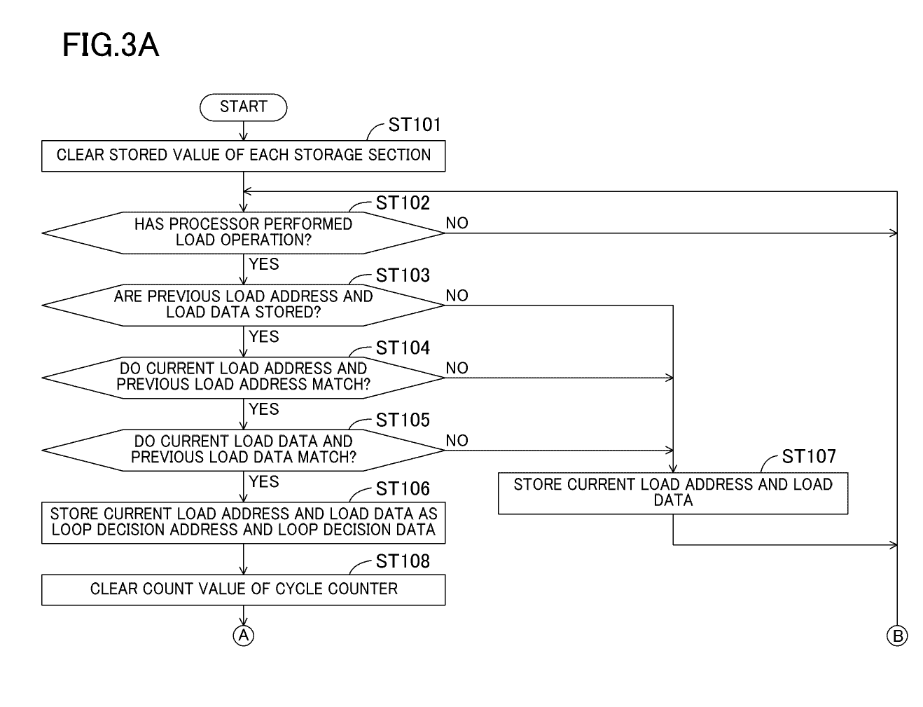

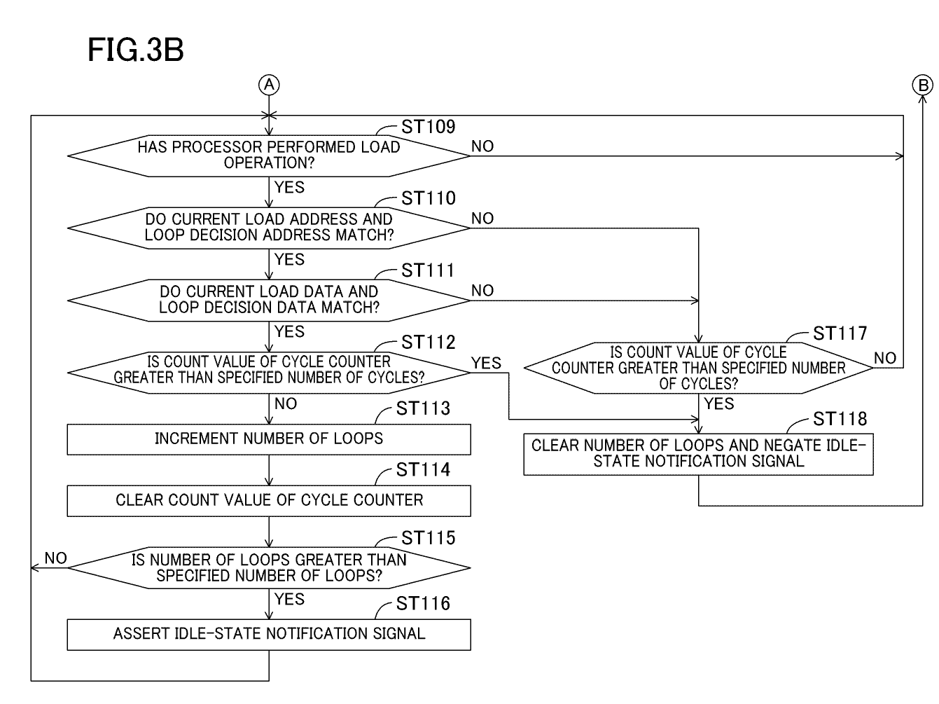

Next, referring to FIGS. 3A and 3B, an operation of the idle-state detection circuit shown in FIG. 1 will be described.

[Steps ST101 and ST102]

First, the control section 107 clears each of the stored values of the load address storage section 101, the load data storage section 103, and the number-of-loops storage section 108 (ST101). Next, the control section 107 monitors whether or not the processor 11 has performed a load operation (ST102).

[Step ST103]

When the processor 11 has performed a load operation, the control section 107 refers to each of the stored values of the load address storage section 101 and the load data storage section 103, and determines whether or not a previous load address (address referred to by the processor 11 in the previous load operation by the processor 11) and a previous load data (data loaded by the processor 11 in the previous load operation by the processor 11) are respectively stored in the load address storage section 101 and the load data storage section 103.

[Step ST104]

If the previous load address and the previous load data are stored (for example, a load operation has been performed more than once by the processor 11), the control section 107 refers to the comparison result generated by the comparison section 102, and determines whether or not the current load address (address referred to by the processor 11 in the current load operation by the processor 11) matches the previous load address stored in the load address storage section 101.

[Step ST105]

If the current load address matches the previous load address, the control section 107 refers to the comparison result generated by the comparison section 104, and determines whether or not the current load data (data loaded by the processor 11 in the current load operation by the processor 11) matches the previous load data stored in the load data storage section 103.

[Step ST106]

If the current load data matches the previous load data, the control section 107 stores the current load address in the load address storage section 101 as a loop decision address, and stores the current load data in the load data storage section 103 as loop decision data.

[Step ST107]

Meanwhile, if no previous load address and no previous load data are stored (for example, a load operation is first performed by the processor 11), if the current load address does not match the previous load address, or if the current load data does not match the previous load data, then the control section 107 stores the current load address in the load address storage section 101, and stores the current load data in the load data storage section 103. Next, the process loops back to step ST102.

[Steps ST108 and ST109]

After storing the loop decision address and the loop decision data respectively in the load address storage section 101 and in the load data storage section 103 at step ST106, the control section 107 clears the count value of the cycle counter 105 (ST108). Next, the control section 107 monitors whether or not the processor 11 has performed a load operation (ST109).

[Step ST110]

When the processor 11 has performed a load operation, the control section 107 refers to the comparison result generated by the comparison section 102, and determines whether or not the current load address matches the loop decision address stored in the load address storage section 101.

[Step ST111]

If the current load address matches the loop decision address, the control section 107 refers to the comparison result generated by the comparison section 104, and determines whether or not the current load data matches the loop decision data stored in the load data storage section 103.

[Step ST112]

If the current load data matches the loop decision data, the control section 107 refers to the comparison result generated by the comparison section 106, and determines whether or not the count value of the cycle counter 105 is greater than the specified number of cycles CKX.

[Steps ST113, ST114, and ST115]

If the count value of the cycle counter 105 is less than or equal to the specified number of cycles CKX, the control section 107 increments the number of loops stored in the number-of-loops storage section 108 (ST113). In addition, the control section 107 clears the count value of the cycle counter 105 (ST114). Then, the comparison section 109 compares the number of loops stored in the number-of-loops storage section 108 with the specified number of loops LPX (ST115). If the number of loops stored in the number-of-loops storage section 108 is less than or equal to the specified number of loops LPX, the process loops back to step ST109.

[Step ST116]

If the number of loops stored in the number-of-loops storage section 108 is greater than the specified number of loops LPX, the comparison section 109 asserts the idle-state notification signal S109, after which the process loops back to step ST109.

[Step ST117]

Meanwhile, if the current load address does not match the loop decision address, or if the current load data does not match the loop decision data, then the control section 107 determines whether or not the count value of the cycle counter 105 is greater than the specified number of cycles CKX.

[Step ST118]

If the count value of the cycle counter 105 is greater than the specified number of cycles CKX, the control section 107 clears the number of loops stored in the number-of-loops storage section 108. Accordingly, the comparison section 109 negates the idle-state notification signal S109, after which the process loops back to step ST102.

Thus, it is detected that the processor 11 repeats every predetermined number of clocks an operation to load the same data as the loop decision data from the same address as the loop decision address, and if the number of iterations exceeds the specified number of cycles CKX, the idle-state notification signal S109 is asserted. This prevents a conventional incorrect detection, thereby allowing an idle state of the processor 11 to be correctly detected.

In addition, since the clock supply section 16 and the voltage supply section 17 respectively reduce the frequency of the clock signal CLK and the voltage value of the drive voltage VD in response to the idle-state notification signal S109, waste of power in the processor 11 can be reduced. Note that reduction in either the frequency of the clock signal CLK or the voltage value of the drive voltage VD allows waste of power in the processor 11 to be reduced.

Moreover, the power consumption of the processor can be reduced without changing existing software, and thus reduction in development cost can be achieved.

### Second Embodiment

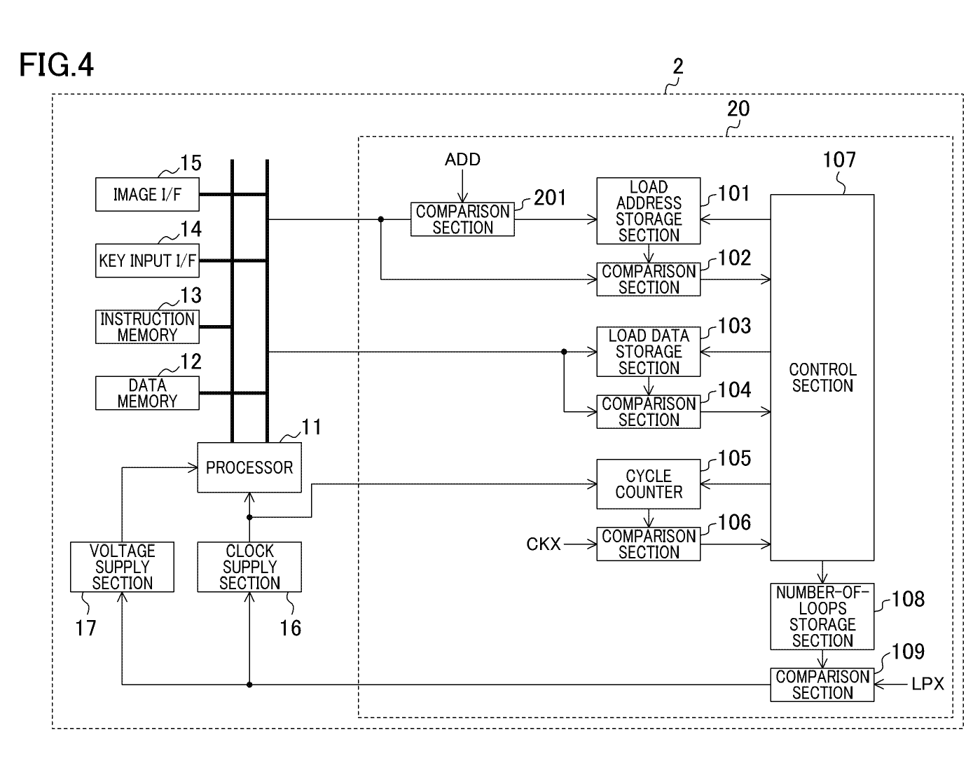

FIG. 4 illustrates an example configuration of a semiconductor IC 2 according to the second embodiment. The semiconductor IC 2 includes an idle-state detection circuit 20 instead of the idle-state detection circuit 10 shown in FIG. 1. The other part of the configuration is similar to that of FIG. 1. The idle-state detection circuit 20 includes a comparison section 201 in addition to the components shown in FIG. 1. The comparison section 201 compares an address (load address) referred to by the processor 11 with a preset specified address area ADD, and if the load address is located in the specified address area ADD, the comparison section 201 transfers the load address to the load address storage section 101.

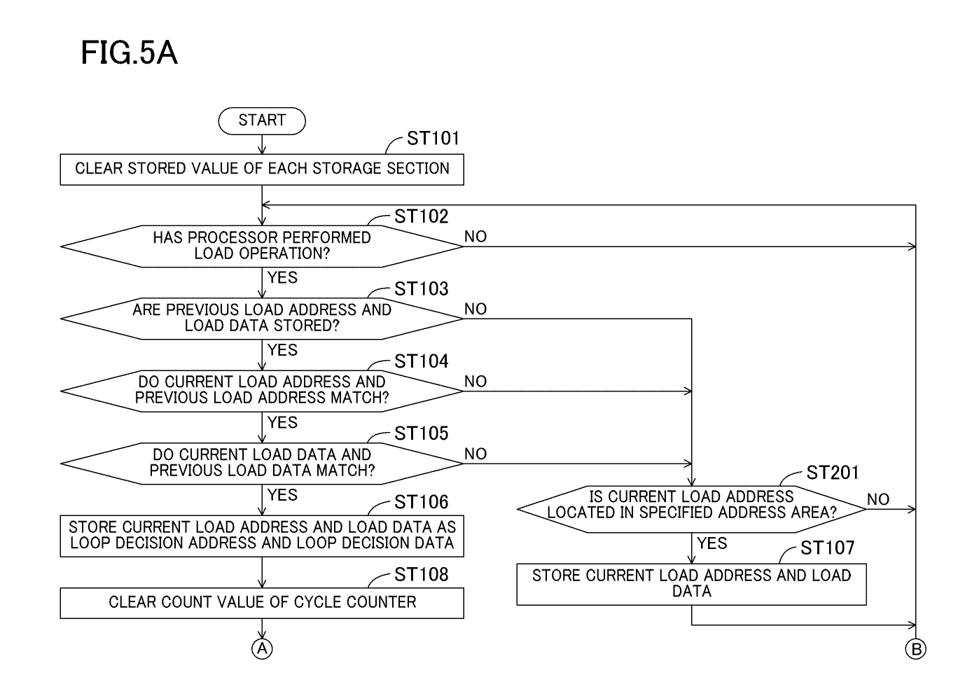

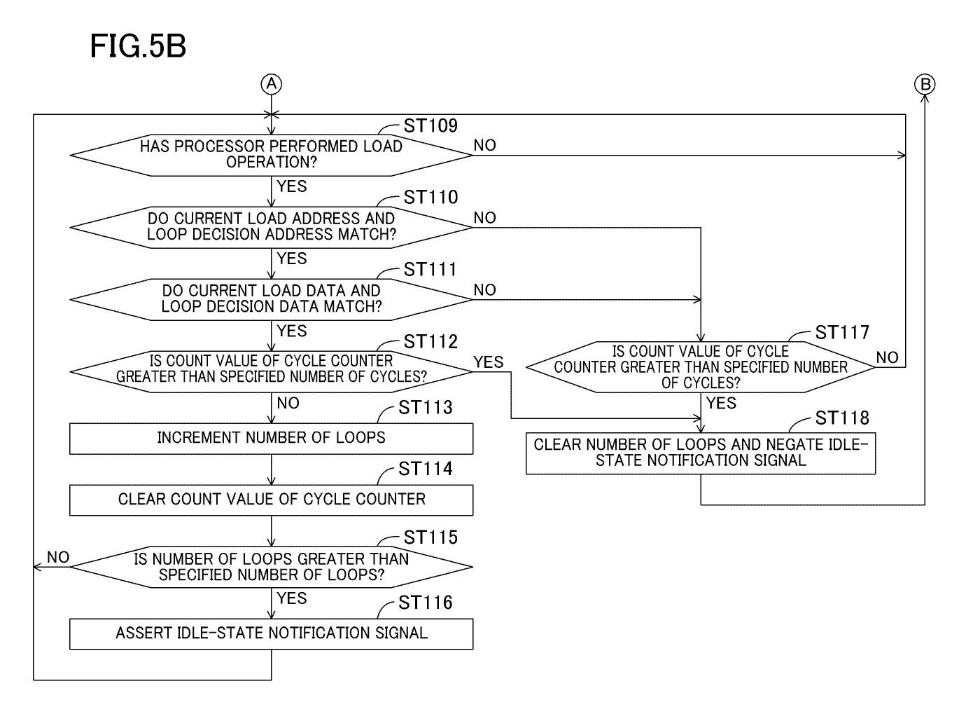

Next, referring to FIGS. 5A and 5B, an operation of the idle-state detection circuit 20 shown in FIG. 4 will be described. As shown in FIGS. 5A and 5B, the idle-state detection circuit 20 executes step ST201 in addition to steps ST101-ST118 shown in FIGS. 3A and 3B.

[Step ST201]

The comparison section 201 compares the current load address with the specified address area ADD. If the current load address is located in the specified address area ADD, the process proceeds to step ST107; otherwise, the process loops back to step ST102.

At step ST107, the control section 107 stores the current load address transferred by the comparison section 201 in the load address storage section 101, and stores the current load data in the load data storage section 103. Next, the process loops back to step ST102.

Thus, if the load address is located in the specified address area ADD, the load address and the load data are stored, while, if the load address is not located in the specified address area ADD, the load address and the load data are not stored. In this way, limiting the load address for detecting an idle state allows an idle state of the processor 11 to be detected more correctly. For example, by specifying as the specified address area ADD an address area which includes a register address of the key input interface, but does not include addresses of a FIFO memory, a load operation to continuously load data from the FIFO memory can be prevented from being incorrectly detected as an idle state, and at the same time, an operation to continuously refer to the register address of the key input interface can be detected as an idle state.

Note that the specified address area ADD may be a fixed value or a value which can be arbitrarily set. For example, a configuration register etc. may be provided to allow a user to arbitrarily set a specified address area ADD.

### Third Embodiment

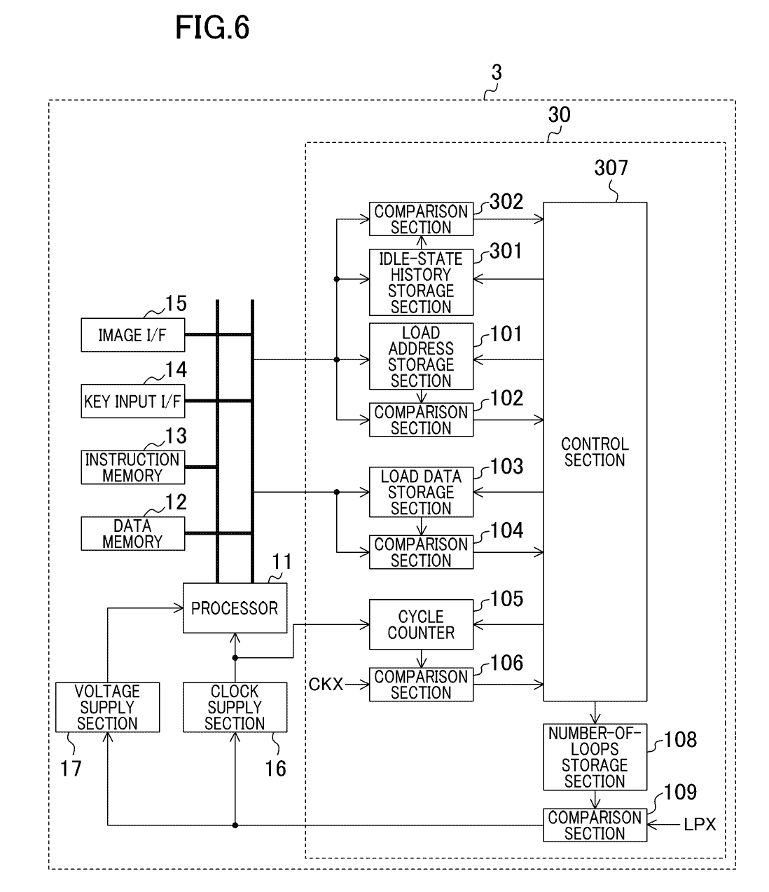

FIG. 6 illustrates an example configuration of a semiconductor IC 3 according to the third embodiment. The semiconductor IC 3 includes an idle-state detection circuit 30 instead of the idle-state detection circuit 10 shown in FIG. 1. The other part of the configuration is similar to that of FIG. 1. The idle-state detection circuit 30 includes an idle-state history storage section 301 and a comparison section 302 in addition to the components shown in FIG. 1. The idle-state history storage section 301 stores an address referred to by the processor 11 as an idle-state history address in response to a control operation by the control section 107. The comparison section 302 compares the address referred to by the processor 11 with the idle-state history address stored in the idle-state history storage section 301.

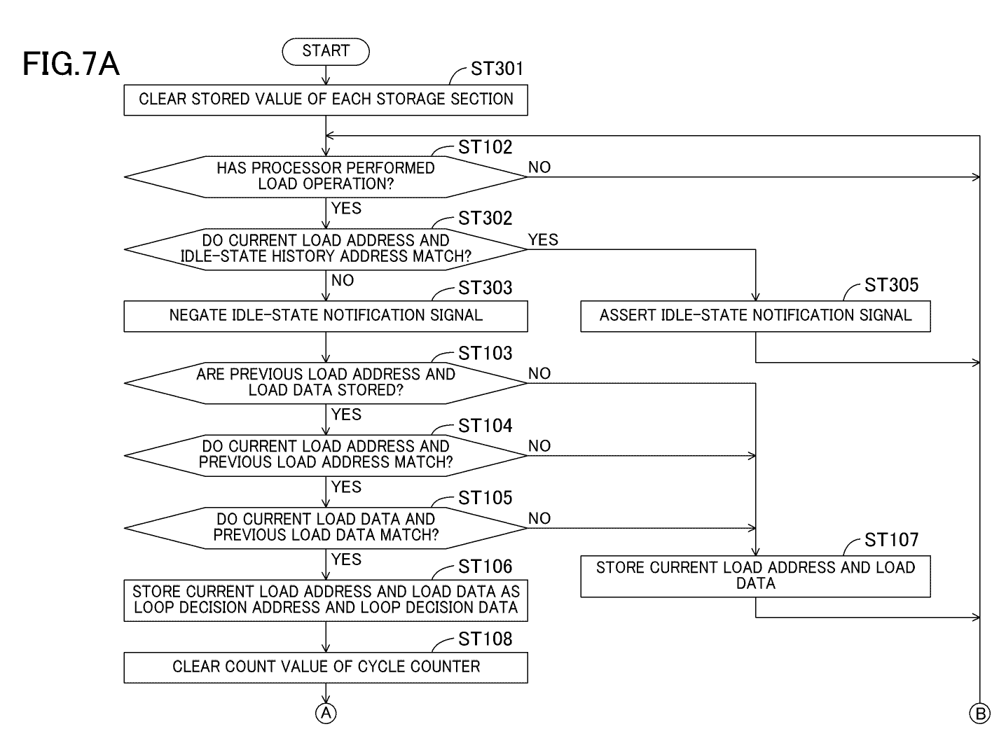

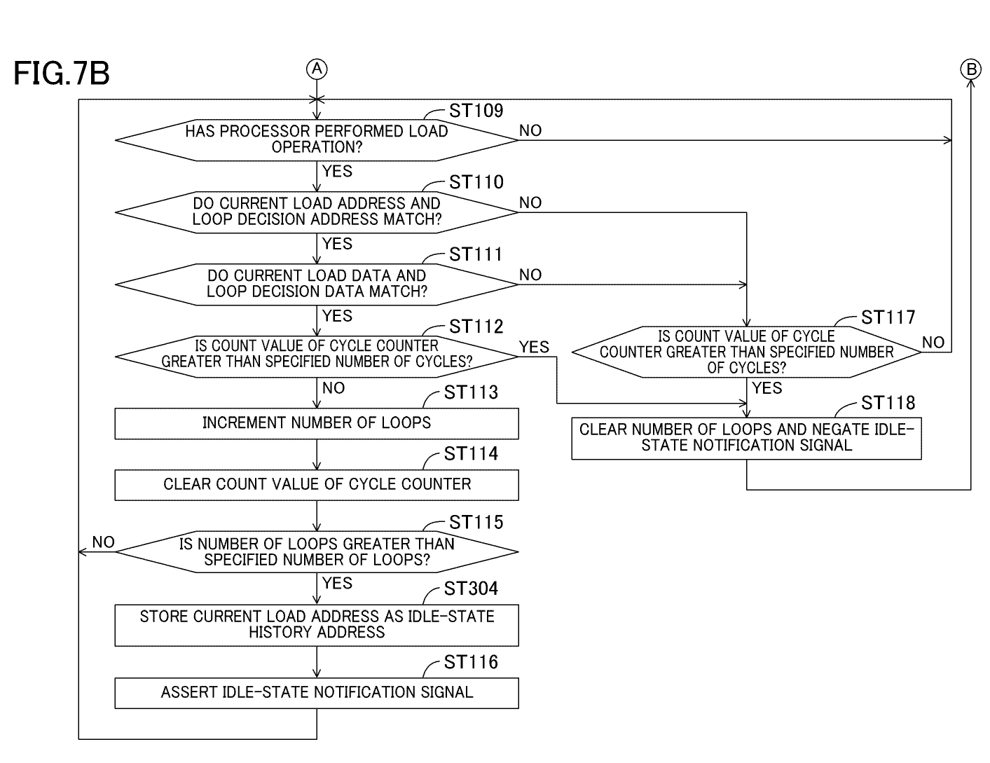

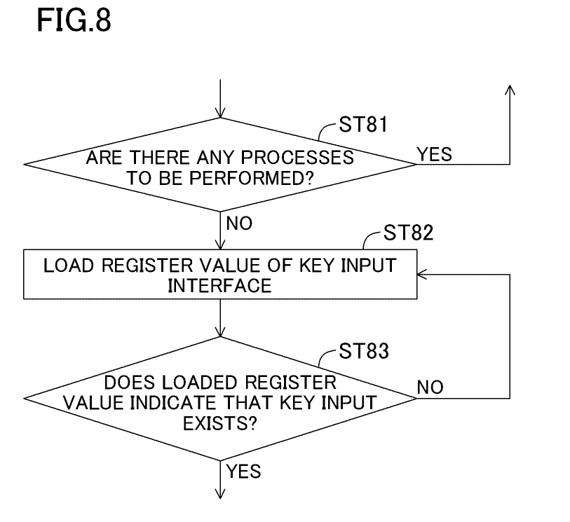

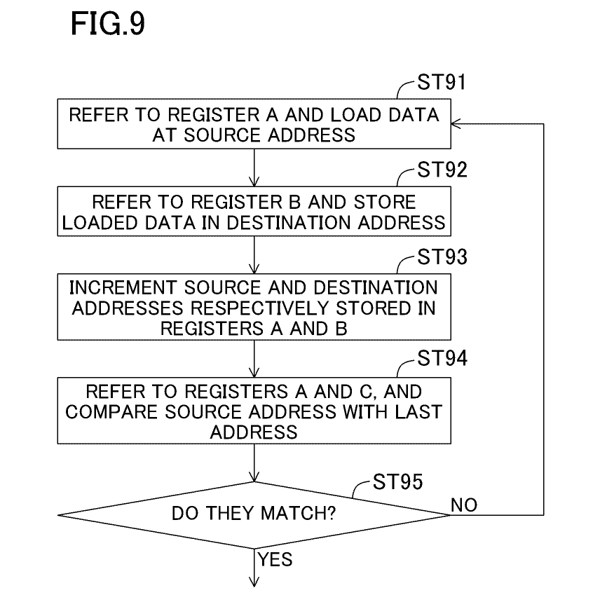

Next, referring to FIGS. 7A and 7B, an operation of the idle-state detection circuit 30 shown in FIG. 6 will be described. As shown in FIGS. 7A and 7B, the idle-state detection circuit 30 executes step ST301 instead of step ST101 shown in FIGS. 3A and 3B, and further executes steps ST302-ST305.

[Step ST301]

First, the control section 107 clears each of the stored values of the load address storage section 101, the load data storage section 103, and the number-of-loops storage section 108, and further clears the stored value of the idle-state history storage section 301. Next, the process proceeds to step ST102. At step ST102, the control section 107 monitors whether or not the processor 11 has performed a load operation.

[Step ST302]

When the processor 11 has performed a load operation, the control section 107 refers to the comparison result generated by the comparison section 302, and determines whether or not the current load address matches the idle-state history address stored in the idle-state history storage section 301.

[Step ST303]

If the current load address does not match the idle-state history address (for example, no idle-state history address is stored), the control section 107 controls the number-of-loops storage section 108 so that the idle-state notification signal S109 is negated. Then, the process proceeds to step ST103, and the process of steps ST103-ST115 is executed. At step ST115, the comparison section 109 compares the number of loops stored in the number-of-loops storage section 108 with the specified number of loops LPX.

[Step ST304]

If the number of loops stored in the number-of-loops storage section 108 is greater than the specified number of loops LPX, the control section 107 stores the current load address in the idle-state history storage section 301 as the idle-state history address. Next, the process proceeds to step ST116.

[Step ST305]

Meanwhile, if the current load address matches the idle-state history address at step ST302, the control section 107 sets the number of loops so that the number of loops set in the number-of-loops storage section 108 exceeds the specified number of loops LPX. Accordingly, the comparison section 109 asserts the idle-state notification signal S109, after which the process loops back to step ST102.

Thus, by storing a load address as the idle-state history address when the processor 11 is in an idle state, it can be presumed that the processor 11 is in an idle state if an idle state of the processor 11 is once complete and thereafter the processor 11 refers to the same address as the idle-state history address. In addition, by asserting the idle-state notification signal S109 without executing the process of steps ST103-ST116 when the processor 11 refers to the same address as the idle-state history address, early detection of an idle state of the processor 11 can be achieved, thereby allowing early reduction in the power consumption of the processor 11 to be achieved. Note that the idle-state detection circuit 30 may further include the comparison section 201 shown in FIG. 4 in addition to the components shown in FIG. 6.

(Idle-State Condition)

In each of the above embodiments, the control section 107 may determine whether or not the current load data satisfies a preset idle-state condition at steps ST105 and ST111. For example, if an idle-state detection circuit is applied to a system in which the processor transitions to an idle state when data stored in a particular address is greater than a predetermined value, then the idle-state condition may be set to a condition that “the data be greater than a predetermined value.” More specifically, a waiting process using a timer which counts down a count value every clock cycle is one example. Such a waiting process holds the processor 11 in a wait state while the count value of the timer changes from an initial value (e.g., 1000) to a predetermined value (e.g., 500). In such a case, the processor 11 repeats a process of referring to the timer value while the count value of the timer changes from the initial value to the predetermined value. Thus, a waiting process of the processor can be detected as an idle state by replacing steps ST101, ST105-ST107, and ST111 respectively with the following steps ST101′, ST105′-ST107′, and ST111′.

[Step ST101′]

The control section 107 clears each of the stored values of the load address storage section 101 and the number-of-loops storage section 108, and stores a predetermined value (e.g., 500) in the load data storage section 103. The predetermined value may be a fixed value or a value which can be arbitrarily set.

[Step ST105′]

The control section 107 refers to the comparison result generated by the comparison section 104, and determines whether or not the current load data is greater than the predetermined value. If the current load data is greater than the predetermined value, the process proceeds to step ST106′; otherwise, the process proceeds to step ST107′.

[Step ST106′]

The control section 107 stores the current load address in the load address storage section 101 as the loop decision address.

[Step ST107′]

The control section 107 stores the current load address in the load address storage section 101, after which the process loops back to step ST102.

[Step ST111′]

The control section 107 refers to the comparison result generated by the comparison section 104, and determines whether or not the current load data is greater than the predetermined value. If the current load data is greater than the predetermined value, the process proceeds to step ST112; otherwise, the process proceeds to step ST117.

Moreover, if an idle-state detection circuit is applied to a system in which the processor transitions to an idle state when data stored in a particular address is less than a predetermined value, then the idle-state condition may be set to a condition that “the data be less than a predetermined value.” More specifically, a waiting process using a timer which counts up a count value every clock cycle is one example. Also, in such a case, the processor 11 repeats a process of referring to the timer value while the count value of the timer changes from an initial value (e.g., 500) to a predetermined value (e.g., 1000). Thus, a waiting process of the processor can be detected as an idle state by replacing steps ST101, ST105-ST107, and ST111 respectively with the above steps ST101′, ST105′-ST107′, and ST111′. (Note that the expression “greater than” should be read as “less than” in steps ST105′ and ST111′.)

(Specified Number of Cycles CKX)

In each of the above embodiments, the specified number of cycles CKX may be a fixed value or a value which can be arbitrarily set. For example, a configuration register etc. may be provided to allow a user to arbitrarily set a specified number of cycles CKX. For example, if a predetermined process A is repeated before looping back from step ST13 to step ST11 in the process of checking for an external instruction (shown in FIG. 2), an incorrect detection of an idle state of the processor 11 can be prevented by setting the specified number of cycles CKX so that a corresponding time will be shorter than the time needed to execute the process A.

(Specified Number of Loops LPX)

In each of the above embodiments, the specified number of loops LPX may be a fixed value or a value which can be arbitrarily set. For example, when data is loaded from a FIFO memory, the data is read from the FIFO memory in the order written into the FIFO memory; therefore, the processor 11 repeats a process of referring to the addresses of the FIFO memory. Here, if the values of the data written in the FIFO memory are all “0,” then the processor 11 repeats a process to load same data from a same address. This may cause an incorrect detection of an idle state of the processor 11. Accordingly, setting the specified number of loops LPX to a value greater than or equal to the total number of entries of the FIFO memory prevents the process to load data from the FIFO memory from being incorrectly detected as an idle state.

The idle-state detection devices and methods described above can correctly detect an idle state of the processor, and thus are useful for technology for reducing the power consumption of processors.

It is to be understood that the foregoing embodiments are illustrative in nature, and are not intended to limit the scope of the invention, application of the invention, or use of the invention.

What is claimed is:

1. An idle-state detection circuit for detecting an idle state of a processor, comprising:
an iterative-operation detection section configured to detect that the processor repeats every predetermined number of clocks an operation to load data satisfying a preset idle-state condition from a particular address; and
a decision section configured to compare a number of iterations detected by the iterative-operation detection section with a preset specified number of loops, and to determine that the processor is in an idle state if the number of iterations is greater than the specified number of loops.

2. The idle-state detection circuit of claim 1, wherein
the iterative-operation detection section includes
a match-of-address detection section configured to detect that an address referred to by the processor matches the particular address,
a satisfaction-of-condition detection section configured to detect that data loaded by the processor satisfies the idle-state condition, and
a loop detection section configured to detect that the detection operations by the match-of-address detection section and the satisfaction-of-condition detection section are repeated every predetermined number of clocks.

3. The idle-state detection circuit of claim 1, wherein
the idle-state condition is to match data loaded by the processor in a previous load operation by the processor.

4. The idle-state detection circuit of claim 1, wherein
the idle-state condition is to be greater than a preset predetermined value.

5. The idle-state detection circuit of claim 1, wherein
the idle-state condition is to be less than a preset predetermined value.

6. The idle-state detection circuit of claim 1, wherein
the specified number of loops can be arbitrarily set.

7. The idle-state detection circuit of claim 1, wherein
the particular address is located in a previously specified address area.

8. The idle-state detection circuit of claim 1, wherein
the predetermined number of clocks can be arbitrarily set.

9. The idle-state detection circuit of claim 1, further comprising:
an idle-state history storage section configured to store an address referred to by the processor when it is determined by the decision section that the processor is in an idle state, wherein
the decision section determines that the processor is in an idle state without comparing the number of iterations with the specified number of loops when it has been detected that the address referred to by the processor matches the address stored by the idle-state history storage section.

10. The idle-state detection circuit of claim 1, wherein
the decision section determines that the processor is not in an idle state when at least one of that an address referred to by the processor does not match the particular address, or that data loaded by the processor does not satisfy the idle-state condition, has been detected.

11. A semiconductor integrated circuit, comprising:
the idle-state detection circuit of claim 1;
the processor; and
a driver circuit configured to supply a clock signal and a drive voltage for driving the processor to the processor,
wherein
the driver circuit reduces at least one of a frequency of the clock signal or a voltage value of the drive voltage if it is determined by the decision section that the processor is in an idle state.

12. An idle-state detection method for detecting an idle state of a processor, comprising the steps of:
(a) detecting that the processor repeats every predetermined number of clocks an operation to load data satisfying a preset idle-state condition from a particular address; and
(b) determining that the processor is in an idle state if a number of iterations detected in the step (a) is greater than a preset specified number of loops.
